(19) United States
(12) Patent Application Publication
(10) Pub. No.: US 2025/0345995 A1
(43) Pub. Date: Nov. 13, 2025

(54) EXTERNALLY-ACTUATED DYNAMIC MOLDING BED SYSTEM AND METHOD

(71) Applicant: Universal City Studios LLC, Universal City, CA (US)

(72) Inventor: Timothy Eck, Windemere, FL (US)

(21) Appl. No.: 19/201,512

(22) Filed: May 7, 2025

Related U.S. Application Data
(60) Provisional application No. 63/644,123, filed on May 8, 2024.

(51) Int. Cl. B29C 64/245; B33Y 30/00

(52) U.S. Cl. CPC B29C 64/245; B33Y 30/00

(57) ABSTRACT

A system is provided that includes a dynamic molding bed assembly. The dynamic molding bed assembly includes a table frame, a passive rod assembly, an actuator and a controller. The passive rod assembly includes a plurality of rods, wherein each individual rod of the plurality of rods is independently adjusted to change a stroke length position relative to the table frame. The actuator couples to at least one individual rod of the plurality of rods to adjust the stroke length position of the at least one individual rod of the plurality of rods based on control instructions. The controller generates the control instructions to adjust the stroke length position and activates the passive rod assembly to secure at least one individual rod of the plurality of rods to the stroke length position.

### CROSS-REFERENCE TO RELATED APPLICATION

This application claims priority from and the benefit of U.S. Provisional Application Ser. No. 63/644,123, entitled “EXTERNALLY-ACTUATED DYNAMIC MOLDING BED SYSTEM AND METHOD”, filed May 8, 2024, which is hereby incorporated by reference in its entirety.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The subject matter disclosed herein relates to a dynamic molding bed assembly, and more specifically, to a plurality of rods that may be externally actuated.

Amusement parks or theme parks may include various entertainment attractions useful in providing enjoyment to guests of the amusement parks. For example, the attractions may include a ride attraction (e.g., closed-loop track, dark ride, thrill ride, or other similar ride), and the attraction may be part of a themed environment that may be traditionally established using equipment, furniture, building layouts, props, decorations, displayed media, and so forth. Structures in these environments may be constructed using conventional building techniques, and components of the structures may be custom-built for the themed environment. However, forming these custom-built components is complex and time-consuming.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system is provided that includes a dynamic molding bed assembly. The dynamic molding bed assembly includes a table frame, a passive rod assembly, an actuator and a controller. The passive rod assembly includes a plurality of rods, wherein each individual rod of the plurality of rods is independently adjusted to change a stroke length position relative to the table frame. The actuator couples to at least one individual rod of the plurality of rods to adjust the stroke length position of the at least one individual rod of the plurality of rods based on control instructions. The controller generates the control instructions to adjust the stroke length position and activates the passive rod assembly to secure at least one individual rod of the plurality of rods to the stroke length position.

In an embodiment, a system is provided. The system includes a dynamic molding bed assembly. The dynamic molding bed assembly includes a table frame, a passive rod assembly, and a controller. The passive rod assembly includes a plurality of rods, wherein each individual rod is coupled to a rod end effector, a mount, a cylinder housing, a spring, and a rod lock. The spring is used to generate tension based on a stroke length position of the individual rod. The rod lock is used to transition from a locked state to an unlocked state, wherein the unlocked state is configured to allow adjustment of the stroke length position of the at least one individual rod of the plurality of rods. The controller generates instructions to adjust the stroke length position of at least one individual rod and activate the passive rod assembly to secure the at least one individual rod of the plurality of rods to the stroke length position.

In an embodiment, a method of operating a system is provided. The method includes receiving, via the controller, instructions indicative of a stroke length position corresponding to the first rod of the plurality of rods and actuating, via an actuator, the first rod of the plurality of rods. Further, the method includes securing, via the rod lock, the stroke length position of the first rod of the plurality of rods.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a system including a dynamic molding bed assembly, in accordance with embodiments described herein;

FIG. 2 is a schematic illustration of a portion of the dynamic molding bed system of the system of FIG. 1, in accordance with embodiments described herein;

FIG. 3 is a section view of a schematic illustration of a passive rod assembly of the dynamic molding bed system of FIG. 1, in accordance with embodiments described herein;

FIG. 4 is a section view of a schematic illustration of an individual rod of the dynamic molding bed assembly of FIG. 1 during actuation by an external device, in accordance with embodiments described herein;

FIG. 5 is a perspective view of an embodiment of the dynamic molding bed system of FIG. 1, in accordance with embodiments described herein; and

FIG. 6 is a flow diagram of a method employed to actuate a passive rod assembly of FIG. 1, in accordance with embodiments described herein.

### DETAILED DESCRIPTION

One or more specific embodiments will be described below. In an effort to provide a concise description of these embodiments, not all features of an actual implementation are described in the specification. It should be appreciated that, in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An amusement park may enhance a guest experience by providing themed environments. These themed environments may be established, at least in part, using themed structures situated in or around the amusement park, amusement rides, walkable areas, and the like, and may be positioned within view of the guest. Additionally, themed structures may be constructed for attractions of the amusement park, such as amusement rides, elevated walkable areas, viewing platforms, and the like to provide immersive guest experiences. For example, themed structures may provide physical components of a themed environment. In certain cases, themed structures may provide fantastical narrative elements (e.g., volcanos, dinosaurs, alien environments) that involve irregular shapes and/or surfaces that cannot be formed with planar or right-angle configurations or conventional building materials.

Themed structures of an amusement park may involve component parts that are manufactured separately prior to assembly at an amusement park. Further, because themed structures may have different shapes, forms, and sizes than those of conventional structures (e.g. conventional residential, commercial, or industrial structures), custom design and/or construction may be involved. However, custom design and construction may be expensive and time-consuming. Such extensive customization of artificial rockwork panels is cumbersome, may limit production speed, increases weight and thickness of the artificial rockwork panels (e.g., increasing assembly time), and may limit scalability. As such, there is a need for scalable, at least partially modular, and less burdensome customization of the artificial rockwork panels, e.g., rockwork chips.

The disclosed embodiments provide systems and methods that may be used to dynamically support the construction and/or fabrication of a themed structure. The disclosed techniques permit dynamic reconfiguration of system components to permit different shapes or surfaces of a themed structure to be formed. The themed structure may include the formation of rockwork panels. A dynamic molding bed assembly may be used to support formation of the panels using additive construction (e.g., additive manufacturing, 3D printing, concrete printing, printing of a cementitious material and/or mixture) without need of sacrificial support materials in embodiments. Additionally, the present disclosure relates to systems and methods for actuation of the dynamic molding bed assembly to form the dynamic underlying support structure to allow formation of artificial rockwork panels in non-planar configurations. Further, the dynamic molding bed assembly includes a passive rod assembly that includes rods that are externally actuated to a stroke length position to form a surface in which additive construction (e.g., a printing process, a molding process, a layup process, and the like) is executed on the surface of the system. It should be noted that the passive rod assembly may be substantially fewer degrees of freedom compared to non-passive assemblies (e.g., assemblies in which each rod is self-actuated) to enable large-scale implementation of the passive rod assembly. In some embodiments, the rods are actuated using an external device (e.g., an actuator, a robotic arm, a robotic device) that includes an actuation tool that engages with the rods to set the stroke length position that generates a surface topography desired for additive construction. For example, the robotic device may position the rods to the stroke length to generate the surface topography of carved rock. As such, the artificial rockwork panel may be printed on the surface of the system, e.g., without need for preproduction of static support structures. Further, the system may be actuated by the robotic device to form a different surface topography for subsequent artificial rockwork panel production.

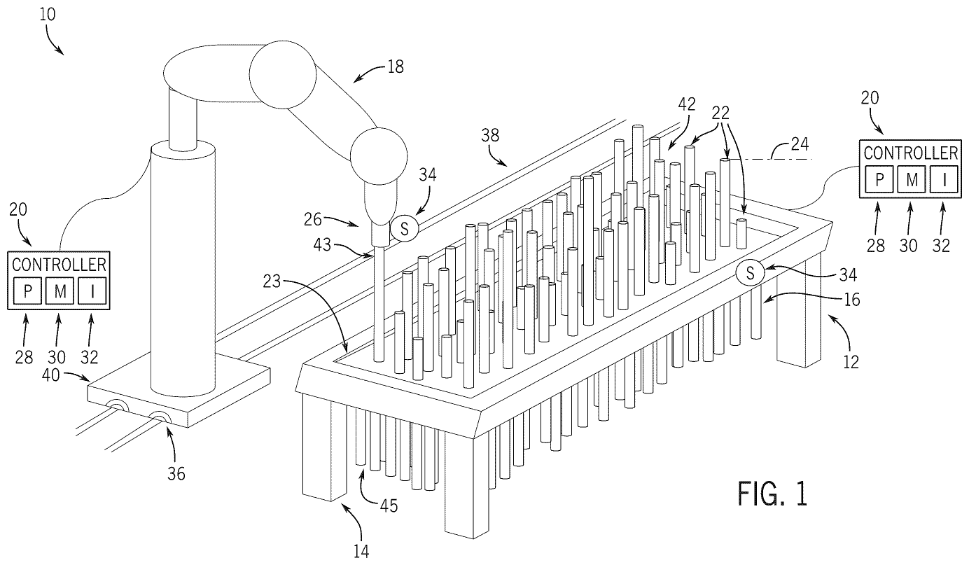

FIG. 1 is a schematic illustration of an embodiment of a dynamic molding bed system 10. The dynamic molding bed system 10 may include a dynamic molding bed 12, at least one table frame 14, a passive rod assembly 16, an external device 18 (e.g., an actuator), and a controller 20. The passive rod assembly 16 may include a plurality of rods 22 that may be independently actuated or moved relative to one another. The rods 22 are used to support formation of artificial rockwork panels of different surface topographies. Each individual rod of the plurality of rods 22 may be actuated to assume a particular stroke length position 24 within a range of potential stroke length positions 24. The stroke length position 24 for each individual rod 22 is a height of the rod 22 relative to the table frame 14. The stroke length position 24 may be an amount of protrusion of the rod 22 from a surface, such as a table surface 23. The stroke length position 24 of each rod 22 (or, in some embodiments, sets of rods 22) may be independently adjusted by the external device 18. In some embodiments, the external device 18 may be a robotic device that may include an actuation tool 26 used to independently adjust the stroke length position 24 of each individual rod 22. Thus, each rod 22 may be actuated relative to the table surface 23 such that an amount of protrusion (e.g., a protruding length) of the rod 22 may be adjusted. In an embodiment, the rod 22 may be pushed or pulled relative to the table surface 23 to change the stroke length position 24. It should be understood that, in embodiments, increasing a length of the stroke length position 24 may result in increasing a portion of the rod 22 that protrudes while decreasing a length of the stroke length position 24 may result in decreasing a portion of the rod 22 that protrudes.

In some embodiments, the controller 20 may control the external device 18 to transition between a default uncoupled state of not in contact (e.g., not touching, separated, uncoupled, disconnected) with the rods 22 to couple to at least one rod of the plurality of rods. In this manner, the external device 18 may be mechanically decoupled (e.g., separate, uncoupled, disconnected) from the plurality of rods 22 of the dynamic molding bed system 10 in the uncoupled default state. For example, as the dynamic molding bed system 10 performs additive construction processes the external device 18 may be decoupled from the table frame 14 and the passive rod assembly 16. In some embodiments, as the external device 18 transitions from the default uncoupled state to couple to the rods 22 the external device 18 may move in proximity of the table frame 14 and/or the passive rod assembly 16. In this manner, the external device 18 may move from rod 22 to rod 22 (e.g., coupling individually to each rod) following an automated protocol to individually position each individual rod 22 of the plurality or rods 22. That is, each individual rod 22 may not be independently actuatable unless acted upon by the external device 18. It should be noted, that the external device 18 may be connected to each individual rod 22 of the plurality of rods 22 or a subset of the plurality of rods 22 for a transient duration and/or a temporal duration of time. The external device 18 may directly connect to each individual rod 22 of the plurality of rods 22 and/or a subset of the plurality of rods 22. Additionally and/or alternatively, the external device 18 may indirectly adjust positions of the rods 22. In this way, the external device 18 may actuate each individual rod 22 of the plurality of rods 22 or the subset of the plurality of rods 22 to a desired stroke length position 24. The controller 20 may include a processor 28, a memory 30, and instructions 32. The controller 20 may be coupled to the table frame 14 and/or the external device 18 (e.g., robotic device, actuator) of the dynamic molding bed system 10. In some cases, the controller 20 monitors a position of the rods 22 and may receive signals from one or more sensors 34 positioned on the dynamic molding bed and/or the external device 18. The signals may be based on sensor data from the sensors 34 and the signals may be used by the controller 20 to determine the stroke length position 24, a lock position, and/or any suitable signal indicative of operation of the dynamic molding bed system 10.

In some embodiments, the controller 20 may control the external device 18 of the dynamic molding bed system 10 based on the control instructions 32 (e.g., building parameters, digital maps of the non-planar configuration, model of topographical features, robotic instructions, motion control commands) that may be stored in the memory 30 and executed by the processor 28 of the controller 20. For example, the control instructions may include computer graphics imagery (CGI) and/or related methods of previsualizing volumetric data. In this manner, the control instructions may include form, texture, scale, and the like. The control instructions may be converted into data that may be provided to the external device 18 and/or any suitable component of the dynamic molding bed system 10. Moreover, the memory 30 may include a volatile memory, such as random-access memory (RAM), and/or nonvolatile memory, such as read-only memory (ROM). The memory 30 may store a variety of information and may be used for various purposes. For example, the memory 30 may store processor-executable instructions (e.g., hardware, software) for the processor 28 to execute, including the control instructions 32 for controlling various components of the dynamic molding bed system 10. The control instructions 32 may control the actuation of the plurality of rods 22 to take on a configuration to form a molding surface 42 desired for formation of the artificial rockwork panels. The processor 28, which may be one or more processors, and/or more generally a processing circuitry, may include any suitable processor or microprocessor capable of executing processor executable code. Moreover, the processor 28 may include multiple microprocessors, one or more “general-purpose” microprocessors, one or more special-purpose microprocessors, and/or one or more application specific integrated circuits (ASICs), or some combination thereof. For example, the processor 28 may include one or more than one reduced instruction set (RISC) or complex instruction set (CISC) processors. The memory 30 and/or the processor 28, or any additional memory and/or processor, may be located in any suitable portion of the dynamic molding bed system 10.

In certain embodiments, the external device 18 may actuate each individual rod 22 to independently adjust the stroke length position 24 to a set stroke length position based on the instructions 32. The operation of the dynamic molding bed system 10 may be a printing process (e.g., additive manufacturing process 3-D printing, concrete printing, etc.) or any suitable operation (e.g., manual molding, tooling processes, and the like) in which dynamic control of a support surface (e.g., fiberglass, fiberglass-reinforced polymer, plaster, silicon) may be desired (e.g., medical operations, architectural building, and the like). Actuation of the rods 22 by the external device 18 to the set stroke length position may cause a particular arrangement of the rods 22 relative to the table surface 23 and to one another to generate the molding surface 42. The molding surface 42 may be formed by the plurality of rods 22. For example, the rods 22 may be adjusted by the external device 18 to form a hill and a valley creating the molding surface 42 that may be used to support one or more layers of non-orthogonal printing (e.g., additive manufacturing). It should be noted, that a robotic device is a non-limiting example of the external device 18. For example, in some embodiments, the external device 18 may be any suitable actuator used to adjust the stroke length position 24 of the dynamic molding bed system 10.

In some embodiments, one or more stroke length positions 24 may create a particular molding surface (e.g., topographical support structure) that may be used to support formation of artificial rockwork panels. For example, formation of an artificial rockwork panel may be supported by the table frame 14 of the dynamic molding bed system 10. The controller 20 may receive instructions 32 to set stroke length positions 24 of the rods 22 based on a topographical map of the artificial rockwork panel. The rods 22 may be adjusted by the external device 18 to form the molding surface 42 that matches the topographical map. The artificial rockwork panel may be printed (e.g., concrete printing) on the molding surface 42. In some instances, the artificial rockwork panel may be formed through printing of one or more layers onto the rods 22. In some instances, the stroke length position 24 may be adjusted by the external device 18 during printing of the artificial rockwork panel. Adjustment of the stroke length position 24 during the printing process may allow for incorporation of various components into the artificial rockwork panel (e.g., within the table frame 14) and/or changes in the molding surface 42 that may allow for dynamic control of the topographical support structure during the printing process. While the illustrated example shows the external device 18 conducting top-down adjustment of the rods 22, with the adjustment being at the molding surface-side or at a first rod end 43, it should be understood that the adjustment may be from an opposing surface, or from a second rod end 45.

In some embodiments, the dynamic molding bed system 10 may be used to print additional rockwork panels with different topographical surfaces. For example, instructions 32 including the topographical map of the additional rockwork panels may be executed by the processor 28. The processor 28 may direct the controller 20 to control the external device 18 to adjust the stroke length position 24 of the rods 22 to proper positions in an iterative process. The controller 20 may also monitor a position of the rods 22. The additional rockwork panels may be printed using the dynamic molding bed system 10 through the iterative process by independently adjusting the rods 22 by the external device 18 after printing one or more artificial rockwork panels. A first rockwork panel may be printed by the dynamic molding bed system 10 when the rods 22 are positioned a first stroke length position. The first rockwork panel may be removed from the table frame 14. The external device 18 may adjust the stroke length position 24 of the rods 22 to a second stroke length position and a second rock work panel may be printed supported by the rods 22. In this manner, various rockwork panels may be constructed through the iterative process of adjusting the rods 22 of the dynamic molding bed system 10. In some instances, the external device 18 used to adjust the stroke length position 24 may include one or more modular connection points that may be changed via a tool changer. It should be noted, that the tool changer may include various devices that may enable modular use of the external device 18. As such, the external device 18 may also be used to execute the printing process of the artificial rockwork panels. The external device 18 may include the actuation tool 26 used to adjust the rods 22 and a print extruder used to extrude material used in the printing process. For example, the external device 18 may include the print extruder that may be used for printing of material (e.g., concrete) onto the dynamic molding bed 12.

It should be noted, that formation of artificial rockwork panels is a non-limiting example of application of the dynamic molding bed system 10. In some embodiments, the dynamic molding bed system 10 may be used to form support for structures used in medical (e.g., cast formation, holding device, etc.), defense, architectural, leisure, immersive experiences, and other suitable applications. For example, in some embodiments, the dynamic molding bed system 10 may be used as part of an immersive experience (e.g., bed of nails, interactive table) of a themed environment. The dynamic molding bed 12may be actuated by guests through physical actuation (e.g., pushing by hand, laying on top of, walking on, etc.). In this manner, guests may actuate the stroke length position 24 of the rods 22 by laying on, touching, and/or positioning the molding surface 42 of the table frame 14 to create impressions (e.g., poster, gesture, or the like) as part of the immersive experience.

In some embodiments, the dynamic molding bed system 10 may include a track coupling 36 used to couple the external device 18 to a track 38. The track 38 may be linear, curvilinear, non-planar (e.g., roller coaster like), and the like. The track coupling 36 may be located on a mount 40 coupled to the external device 18. In some cases, the external device 18 is controlled by the controller 20 to move on the track 38 as part of instructions to actuate the rods 22. Movement of the external device 18 on the track 38 may allow for adjustment of the rods 22 over a range of lateral positions to extend a range of movement of the external device 18. For example, artificial rockwork panels of various sizes may be supported by the dynamic molding bed system 10. The external device 18 may be used to adjust the rods 22 of the dynamic molding bed system 10. In some instances, to support the artificial rockwork panel, the rods 22 may be adjusted by the external device 18 during or subsequent to movement along the track 38. In this manner, support of artificial rockwork panel formation of various sizes may be achieved. In some embodiments, the external device 18 may move without a presence of the track 38. For example, the external device 18 may move relative to the dynamic molding bed 12 using wheels, legs, treads, and the like.

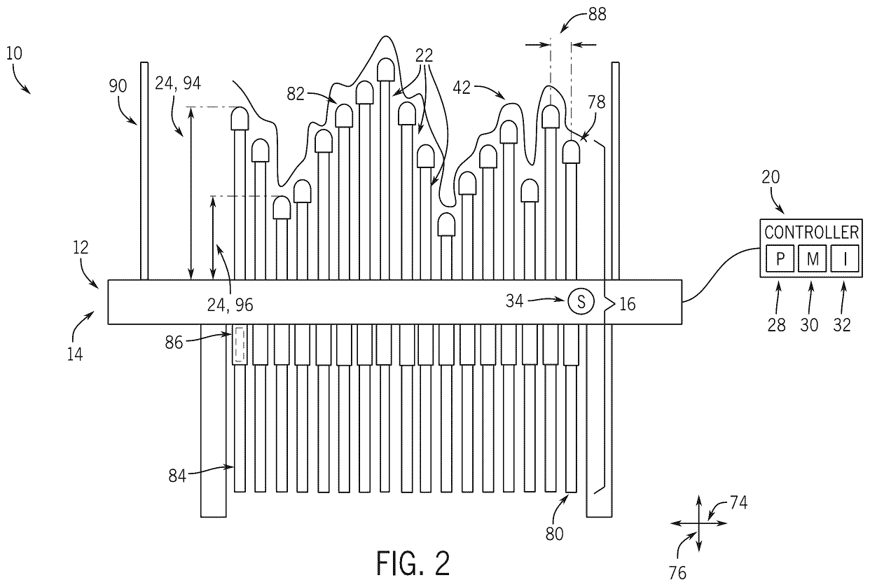

FIG. 2 is a schematic illustration of a portion of the dynamic molding bed system 10 of FIG. 1. To aid the discussion, a set of axes will be referenced. For example, a latitudinal axis 74 may run along the table frame 14, and a longitudinal axis 76 may run through a first end 78 of the passive rod assembly 16 to a second end 80 of the passive rod assembly 16. The portion of the dynamic molding bed system 10 may include the table frame 14, the passive rod assembly 16 and the controller 20. The passive rod assembly 16 includes the plurality of rods 22 including a rod end effector 82. The rod end effector 82 may be positioned on the first end 78 of the passive rod assembly 16. In some embodiments, the rod end effector 82 may be used by the external device 18 (FIG. 1) to actuate the individual rod 22 serving as a point of contact for dynamic adjustment by the external device 18.

In certain embodiments, the passive rod assembly 16 may include a housing 84 (e.g., a cylindrical housing) at the second end 80 of the passive rod assembly 16. The passive rod assembly 16 may include a lock assembly 86 that may include various components to secure at least one individual rod 22 of the plurality of rods 22. The various components may include a mount, a solenoid valve, a rod lock, a piston, a rod gland, a spring, a rod, a piston, a cylindrical housing, and the like discussed further herein. In an embodiment, the rod lock of the lock assembly 86 may include a magnetic lock, an electromagnetic lock, a pneumatic lock, an electric lock, a hydraulic lock, a mechanical spring lock, and the like. Power to the rod lock may be controlled by the solenoid valve. The solenoid valve may provide power to the rod lock during positioning of the rods 22. The solenoid valve may be inactive when the rods 22 are positioned at the stroke length position 24.

In some embodiments, the dynamic molding bed 12 may include the one or more sensors 34. For example, the sensors 34 may be used to send signals based on the sensor data indicative of the stroke length position 24 of each rod 22 to the controller 20. The processor 28, the memory 30, and the instructions 32 may receive the signal and instruct the external device 18 of FIG. 1 to adjust the stroke length position 24 from a first stroke length position 24, 94 to a second stroke length position 24, 96. It should be noted, that each rod 22 may have a different stroke length position, a similar stroke length position, or any suitable stroke length position used to form the molding surface 42. For example, the controller 20 may instruct the external device 18 (of FIG. 1) to position the rods 22 to form the molding surface 42 that will generate a desired topography of the artificial rockwork panel based on the topographical map. In some instances, the topographical map may provide instructions to control actuation of the rods 22 to form the molding surface 42 to support construction of a formable material (e.g., clay, rubber, plastic, elastomers, Play-Doh, paper pulp, organic materials, food, thermal formable materials) into the desired topography.

In some embodiments, the molding surface 42 is formed from rods 22 having a rod resolution 88 (e.g., a pitch distance). The rod resolution 88 is based on a distance between centers of the rod end effectors 82 of one or more adjacent rods 22. Design parameters (e.g., position, distance apart, etc.) of the rods 22 with respect to adjacent rods 22 may determine a level of detail of the molding surface 42. For example, in some embodiments, the rods 22 may be positioned a first distance apart (e.g., a pitch distance) to achieve a first level of detail. In some instances, the first distance apart may be decreased to achieve a second level of detail of the molding surface with a higher resolution than the first level of detail. The second level of detail of the molding surface may produce a rockwork panel with the higher resolution when compared to an artificial rockwork panel with the first level of detail. As such, change in the rod resolution 88 may provide control of the level of detail of one or more layers printed using the dynamic molding bed system 10. The pitch distance between the rods 22 may be regular or irregular. In some embodiments, each of the rods 22 are designed to provide an amount of structural support to enable the plurality of rods 22 to support a load. Each rod 22 of the plurality of rods 22 may be selected to support a portion of the artificial rockwork panel or alternative material supported by the dynamic molding bed 12. Selection of the rods 22 may be based on a size of the rod, a material of the rod, a position of the rod, or the like. The material of the rod may be carbon steel, stainless steel, plastics, aluminum, brass. For example, when a higher amount of structural support is required to support a product of the printing process, stainless steel rods may be used to support the load of the product.

In certain embodiments, the table frame 14 may include a mold dam 90. The mold dam 90 may be configured to provide boundaries during a printing process. The mold dam 90 of the dynamic molding bed system 10may be positioned to confine formation of build materials of various layers (e.g., first layer, second layer, exterior layer) used to form artificial rockwork panels. The mold dam 90 may be removed and/or reconfigured to allow printing of artificial rockwork panels of various sizes. Reconfiguration may include repositioning the mold dam 90 to allow multiple table frames 14 to be positioned in proximity to other table frames 14 to allow modular support formation of the molding surface 42.

In certain embodiments, the dynamic molding bed system 10 may include one or more table frames 14 positioned at various orientations. The illustrated embodiment shows the table frame 14 in a horizontal position in which the rods 22 are positioned perpendicular to the table frame 14. It should be noted, that this is a non-limiting example and the table frame 14 and rods 22 may be positioned in any suitable orientation (e.g., vertical, 45-degree angle, or any suitable combination). For example, the dynamic molding bed system 10 may include a first table frame with rods 22 oriented above the table frame 14. An additional dynamic molding bed assembly may include a second table positioned above the first table frame of the dynamic molding bed system 10. The rods 22 of the second table frame may extend below the second table frame. In this manner, the dynamic molding bed 12 may act as a clamp forming a volumetric mold (e.g., negative space) between the first table frame and the second table frame. The volumetric mold may be used to support formation of an object with different molding surfaces on a top surface and a bottom surface. For example, the volumetric mold may take the form of a human arm. It should be noted, that the rods 22 and/or the table frame 14 may be positioned in a curvilinear, linear, curved, or any suitable configuration.

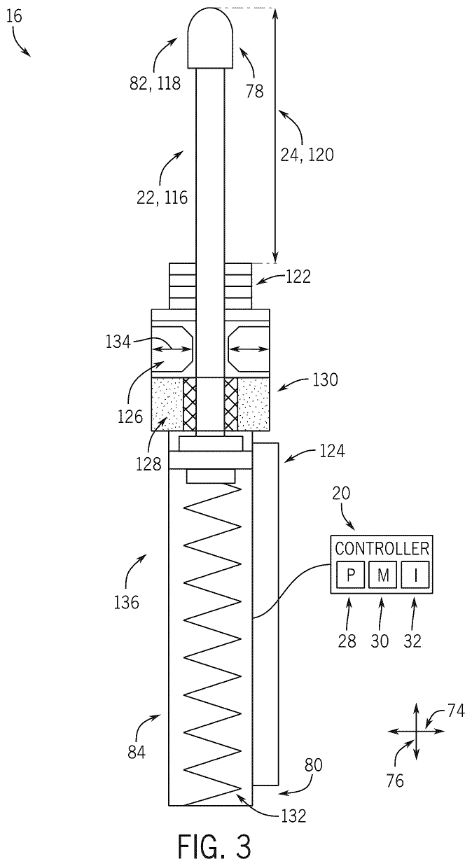

FIG. 3 is a schematic illustration of an individual passive rod assembly 16 of the dynamic molding bed system 10 of FIG. 1 with reference to the latitudinal axis 74 and longitudinal axis 76. As shown an individual rod 22, 116 may be housed in the housing 84 (e.g., cylindrical housing). The rod 22, 116 may include a rod end effector 82, 118 and is secured into a particular stroke length position 24, 120. In some embodiments, the passive rod assembly 16 includes a mount 122, a solenoid valve 124, a rod lock 126, a piston 128, a rod gland 130, a spring 132, or a combination thereof.

In some embodiments, the passive rod assembly 16 may include a spring-extended double-acting cylinder. The spring-extended double-acting cylinder may include one or more pneumatic, hydraulic, and/or electromagnetic components. The rod 22, 116 may be secured into the housing 84 using the mount 122 (e.g., threaded mount, non-threaded mount, a flange mount, and the like) and/or any suitable sealing component (e.g., O-ring, tube seal, or the like). It should be noted, that in some embodiments, the mount 122 may not be included in the passive rod assembly 16. In certain embodiments, the solenoid valve 124 (e.g., mono-stable, bi-stable, closed center, normally open, etc.) may be used to transition the rod lock 126 between a locked state (e.g., solenoid valve off, no power provided to the rod lock 126) and an unlocked state (e.g., solenoid valve on, power provided to the rod lock 126). The locked state may act as a parked position of the rods 22. The locked state may operate in a low-power mode (e.g., no power provided to the rod lock 126) to reduce a power consumption of the passive rod assembly 16. In some embodiments, the external device 18 (of FIG. 1) may be in an uncoupled default state (e.g., separated from the rods 22). In the unlocked state, power may be provided to the rod lock 126. In this manner, the external device 18 (of FIG. 1) may subsequently (e.g., iteratively) move each rod of the rods 22 to the stroke length position 24. Power from the solenoid valve 124 may include pneumatic, hydraulic, electromagnetic, and the like. In this manner, the rods 22 may be positioned (e.g., applying mechanical force to the spring 132) by the external device 18 (of FIG. 1) to a desired stroke length position 24. The rod lock 126 may be set to the locked state by controlling the solenoid valve 124 to deactivate (e.g., provide no power). The locked position of the rod lock 126 may act as a brake to the rods 22 to maintain the stroke length position 24 set by the external device 18 (FIG. 1). In this manner, the dynamic molding bed 12 may be used in the locked state with the rods 22 secured at the stroke length position 24. For example, the passive rod assembly 16 of the dynamic molding bed system 10 may be used during processes (e.g., printing process, molding process, etc.) in the locked position.

In some embodiments, during positioning of the rods 22, as the external device 18 (of FIG. 1) adjusts the rod 22, 116, the piston 128 may compress or extend the spring 132 positioned within the housing 84 to allow the rod 22, 116 to adjust to the stroke length position 24. In this manner, the spring 132 may compress and/or extend moving down or up, respectively (e.g., relative to the housing 84). During actuation of the spring 132 by the external device 18 the stroke length position 24 of the rod 22, 116 (e.g., at least one individual rod of the plurality of rods 22) may be set. Alternatively, movement of the spring 132 may be achieved without the external device 18. passively (e.g., non-fluid power mechanical device). It should be noted, that in some instances, movement of the rod 22, 116 may be achieved through use of pressurized fluid and/or compressed air. In this manner, constant power may be provided to a rod lock 126 to maintain a stroke length position of at least one individual rod of the plurality of rods 22.

In some embodiments, the rod gland 130 may be included in the passive rod assembly 16 to ensure that pressured fluid and/or compressed air remains in the housing 84. It should be noted that in some embodiments, the rod gland 130 may be replaced with a rod bushing and/or a rod bearing. The rod gland 130, rod bushing, and/or rod bearing may provide lateral support to the rod 22, 116. In some instances, additionally and/or alternatively the rod gland 130, rod bushing, and/or rod bearing may seal the passive rod assembly 16. In this manner, a seal may prevent concrete and/or other debris from entering into the passive rod assembly 16. In some instances, during adjustment of the stroke length position 24, 120 of the rod 22, 116 the rod lock 126 may be actuated through pneumatic locking of the rod 22, 116 into the particular stroke length position 24, 120 by activation of the solenoid valve 124. The solenoid valve 124 may be controlled by the controller 20 to control the rod lock 126 (e.g., activate the rod lock 126 for positioning). The rod lock 126 may be released to adjust the particular stroke length position 24, 120. The solenoid valve 124 may be the deactivated position to secure the particular stroke length position 24, 120 after positioning. Further, the solenoid valve 124 may be located external to the housing 84 and/or adjacent to the housing 84. In some embodiments, the solenoid valve 124 is pneumatic and may control flow of compressed air, and/or any suitable fluid (e.g., air, gas, oil, water, and the like). In some alternative embodiments, the solenoid valve 124 may be an electromechanical solenoid. In this manner, the electromechanical solenoid may actuate and/or release locking of the passive rod assembly 16.

In some embodiments, activation of the rod lock 126 may include movement of the rod lock 126 along a lock path 134. The lock path 134 may cause release and/or latch of the rod 22, 116 and/or the piston 128 into a desired position corresponding to the particular stroke length position 24, 120. As shown, the rod 22, 116 is positioned in an extended position 136. The extended position 136 illustrates the spring 132 fully extended. The extended position 136 may be a maximum stroke length position 24, 120 of the rod 22,116. It should be noted, that the maximum stroke length position 24, 120 of the rod 22, 116 may be changed based on a length of the rod 22, 116, a length of the spring 132, or any suitable combination thereof. The dynamic molding bed system 10 may be modular, thereby allowing use of rods 22 of different lengths based on desired parameters of the molding surface 42.

In certain embodiments, a stroke length resolution of the dynamic molding bed system 10 may be based on spatial resolution of the external device 18 (of FIG. 1). The stroke length resolution may determine a level of precision of the external device 18 (of FIG. 1) to adjust the height of the rod 22. For example, an x spatial resolution, a y spatial resolution, and/or a z spatial resolution (e.g., x, y, and z are directions in space) of the external device 18 (of FIG. 1) may determine the stroke length resolution of the dynamic molding bed system 10. In some embodiments, the external device 18 (of FIG. 1) is of a high-resolution (e.g., modern robotic device). In this manner, the stroke length resolution may be controlled on various length scales (e.g., millimeter-scale, micrometer-scale, other sub-millimeter-scale, etc.). However, in some instances, the external device 18 (of FIG. 1) may be an external device with a low-resolution (e.g., human actuated device, rudimentary robotic device, etc.). In this manner, the stroke length resolution may be controlled on a coarse scale (e.g., comparative to high-resolution) that may include on a length scale of an order of magnitude of millimeters, centimeters, and the like.

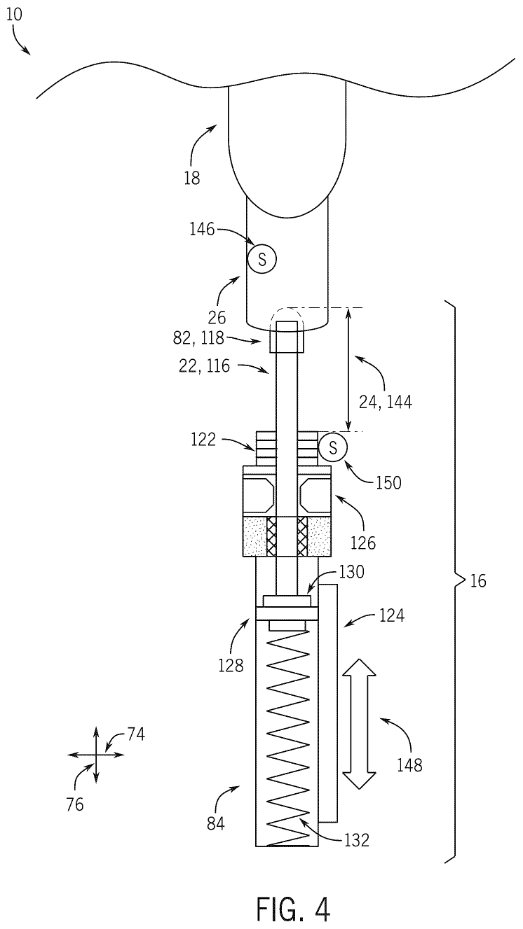

FIG. 4 is a schematic illustration of an individual rod of the dynamic molding bed system 10 of FIG. 1 during independent actuation by the external device 18. The external device 18 may include the actuation tool 26 used to adjust the stroke length position 24,144 of the rod 22,116. It should be noted, that in some embodiments, the external device 18 may adjust the stroke length position 24, 144 without the actuation tool 26. The external device 18 may receive instructions from a sensor 146 positioned on the external device 18 to adjust the stroke length position 24, 144 by pushing down on the rod 22,116. The solenoid valve 124 may control transition of the rod lock 126 to the unlocked position to enable positioning (e.g., movement, adjustment) of the rod 22, 116 via the external device 18. As the external device 18 pushes down on the rod 22, 116 positioned in the housing 84, the passive rod assembly 16 may change the stroke length position 24, 144 by compressing the spring 132 causing the rod 22, 142 to move. Compression of the spring 132 may move a first end of the spring 132 relative to a second end of the spring 132 along a spring path 148. When the external device 18 receives feedback from the sensor 146, based on sensor data indicative of reaching the stroke length position 24, 144, further compression of the spring 132 may end. Additionally and/or alternatively, the passive rod assembly 16 may deactivate the solenoid valve 124 based on a signal received from a linear displacement sensor 150 (e.g., positioned on the passive rod assembly 16). The linear displacement sensor 150 (e.g., stroke length sensor) may send a signal to the controller 20 indicative of the stroke length position 24 of the plurality of rods 22. The passive rod assembly 16 may send a signal to the solenoid valve 124 to deactivate the rod lock 126 to the locked position and secure the piston 128 in a static position that corresponds to the stroke length position 24. In this manner, constant power (e.g., pneumatic power, hydraulic power, electromagnetic power) may not be required once the stroke length position 24 is set. It should be noted, actuation of the passive rod assembly 16 may not require power as the external device 18 may provide energy required for positioning the rod 22, 142 to the stroke length position 24, 144.

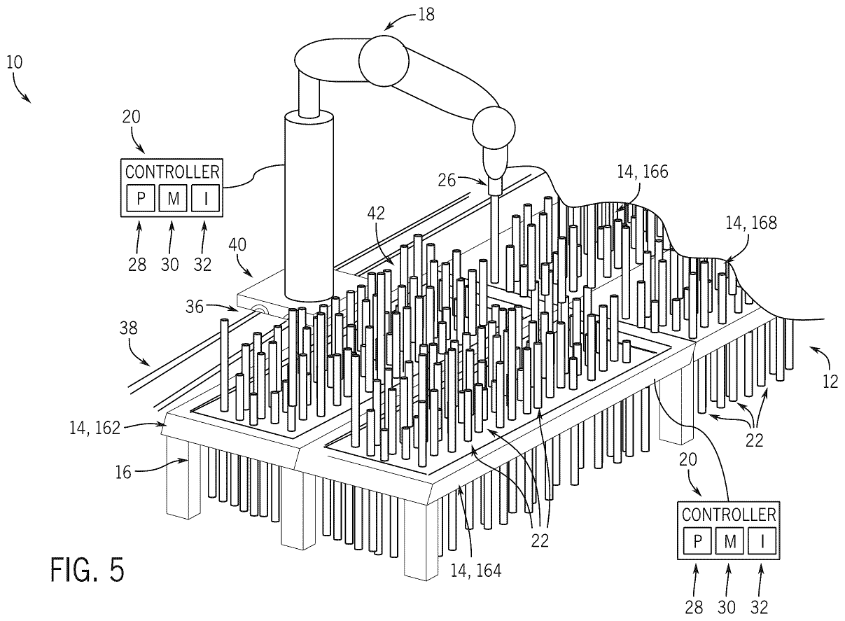

FIG. 5 is a perspective view of an embodiment of the dynamic molding bed system 10 of FIG. 1. The dynamic molding bed system 10 includes various table frames 14, 162, 164, 166, 168, the passive rod assembly 16, the external device 18, and the controller 20. As shown, the various table frames 14 include a first table from 14, 162, a second table frame 14, 164, a third table frame 14, 166 and a fourth table frame 14, 168. The various table frames 14, 162, 164, 166, 168 may provide modularity to a size of the dynamic molding bed 12. For example, addition of the second table frame 14, 164 to the first table frame 14, 162 may allow the dynamic molding bed system 10 to support artificial rockwork panels desired to have a width wider than a width of the first table frame 14, 162. It should be noted, that the various table frames 14, 162, 164, 166, 168 may be positioned on a single plane (e.g., co-planar), one or more additional planes (e.g., x-plane, y-plane, z-plane), or a combination thereof. In this manner, modularity of the dynamic molding bed system 10 may be increased as the various table frames 14, 162, 164, 166, 168 may be positioned to generate surfaces to create molding surfaces of various geometries (e.g., volumetric structures, uneven structures, and the like). In certain embodiments, the external device 18 may be positioned on the mount 40 coupled to the track 38 via the track coupling 36 to facilitate adjustment of rods 22 of the various table frames 14, 162, 164, 166, 168. For example, the external device 18 may be controlled by the controller 20 to move along the track 38 to adjust rods 22 located on the fourth table frame 14, 168. It should be noted, that the track 38 may be positioned in any suitable way to allow the external device 18 to adjust the rods 22 of the dynamic molding bed system 10. Further, it should be noted, in some embodiments, the external device 18 may move without the track 38 (e.g., wheels, tracks, legs, etc.).

In some embodiments, the rods 22 of the dynamic molding bed system 10 may be adjusted simultaneously through the use of a form (e.g., a mold, a positive form). The form may include a first surface that may have topography corresponding to a desired support structure. The form may be of various sizes and may be formed prior to use in combination with the dynamic molding bed system 10. The form may be positioned on a surface of the rods 22 of the passive rod assembly 16 and/or a portion of the rods 22 of the passive rod assembly 16. The form may be positioned manually and/or by the external device 18. As the form is positioned on the rods 22 and table frame 14 of the dynamic molding bed system 10, the one or more of the rods 22 may adjust based on the position and/or geometry of the form. The controller 20 may control one or more of the rods 22 to lock into place. As such, the form may be removed and the rods 22 may form the molding surface 42 corresponding to topography of the desired support structure. For example, the form may be a carving of a desired rock face of the artificial rockwork panel. The desired rock face may be positioned on the rods 22. A portion of the rods 22 may adjust to the stroke length position 24 corresponding to a surface of the desired rock face. The controller 20 may activate the rods 22 to simultaneously lock into various stroke length positions. As such, the molding surface 42 of the dynamic molding bed 12 may be used to support subsequent formation of the artificial rockwork panel with the desired rock face or surface contouring.

In certain embodiments, the rods 22 may form the molding surface 42 and be coupled to a substrate (e.g., lathing, mesh, fabric, textile, tarping) to aid in supporting the formation of the artificial rockwork panels. The substrate may be coupled to the rods 22 with a fastener (e.g., clip, hook, etc.). The substrate may provide a three-dimensional surface to allow the printing process to proceed. In this manner, the substrate may ensure that a material used during the printing process may not interact with the passive rod assembly 16. The substrate may also facilitate removal of the artificial rockwork panel from the dynamic molding bed system 10. For example, the substrate may be a mesh that may be easily removed from the rod end effectors 82 (FIG. 2) of the rods 22. Ease in removal of the mesh may ensure the artificial rockwork panel is not damaged after the printing process during removal from the dynamic molding bed system 10.

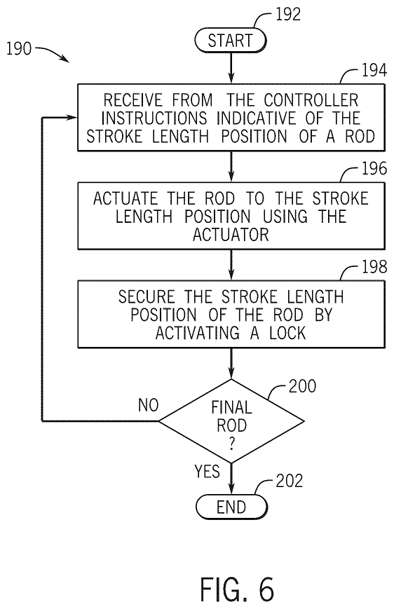

FIG. 6 is a flow chart of a process 190 of adjusting the rods 22 of the dynamic molding bed system 10. As previously noted, procedures such as the process 190 include steps illustrated in a particular order. However, it should be understood that the order of operations may be modified, rearranged, truncated, or the like while keeping within the scope of the present disclosure.

At block 192, the dynamic molding bed system 10 receives instructions 32 from the controller 20 to initiate the process 190. The instructions 32 may include a number of rods 22 to actuate. At block 194, the dynamic molding bed system 10 receives from the controller 20 instructions 32 indicative of the desired stroke length position corresponding to an individual rod (e.g., a rod, a first rod) of the plurality of rods 22. The controller 20 may be coupled to one or more components (e.g., robotic device, table frame, passive rod assembly) of the dynamic molding bed 12. In some instances, the instructions 32 may include the topographical map including the desired or set stroke length positions of each rod of the plurality of rods 22. The topographical map may be based on a desired surface of the artificial rockwork panel. The desired stroke length positions may vary from the actual or current stroke length positions, which may be at a resting or default state. In an embodiment, the rods 22 may be in a configuration associated with a last or previous operation, and the controller 20 accesses the current configuration based on sensor data. Thus, for each rod 22 that is not at a desired or set stroke length position based on the instructions 32, the controller 20 provides instructions 32 to adjust the stroke length position of that rod 22. However, certain rods 22 may already be at the desired or set stroke length position and may not be adjusted in embodiments. At block 196, the dynamic molding bed system 10 may actuate the individual rod of the plurality of rods 22 to the stroke length position 24 of the individual rod using the external device 18. The external device 18 may receive instructions 32 from the controller 20 indicating that the stroke length position is set.

At block 198, the dynamic molding bed system 10 secures the stroke length position 24 of the individual rod by activating the rod lock 126. For example, the controller 20 may control the solenoid valve 124 to actuate the rod lock 126. In some instances, actuation of the rod lock 126 may allow extension or retraction of the spring 132 within the housing 84 positioned on the second end 80 of the passive rod assembly 16. In some instances, the external device 18 may include the actuation tool 26. The actuation tool 26 may be used to adjust the position of the individual rod of the plurality of rods 22. The spring 132 may move along the spring path 148 (e.g., compression and/or extension) during adjustment of the stroke length position. Further, the dynamic molding bed system 10 may in parallel (e.g., via a group of adjacent rods via an actuation tool 26) or in series (e.g., iteratively) operate the rods 22 to adjust the stroke length position based on the instructions (e.g., topographical map).

In this manner, at block 200 the dynamic molding bed system 10 determines based on the number of rods if all rods of the plurality of rods have been actuated. If a final rod (e.g., last rod of the plurality of rods) has been actuated the process 190 proceeds to block 202 and ends the process. In some embodiments, the process 190 may determine at block 200 that the final rod has not been actuated and may return to block 194. As such, the external device 18 actuates (e.g., adjusts) different rods 22 and/or a next rod of the passive rod assembly 16 of the dynamic molding bed system 10 to the desired stroke length position. In this manner, actuation of each rod of the plurality of rods may be executed until the process 190 is terminated.

While only certain features of the disclosed technology have been illustrated and described herein, many modifications and changes will occur to those skilled in the art. It is, therefore, to be understood that the appended claims are intended to cover all such modifications and changes as fall within the true spirit of the disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Procedures, in accordance with the present disclosure for providing the system include various different steps and procedural aspects. Some of these steps or procedures may be performed in parallel or in varying different orders. Some steps may be processor-based operations and may involve controlled equipment (e.g., robotic devices, actuators). Further, some procedures may be iteratively performed to achieve a desired outcome. Accordingly, while various different procedural steps may be discussed in a particular order herein, the procedural steps may not necessarily be performed in the order of introduction, as set forth by the present disclosure. While some specific steps of an operation may necessarily occur before other specific steps (e.g., as dictated by logic), the listing of certain orders of operation are primarily provided to facilitate discussion. For example, indicating that a first step or a beginning step includes a particular operation is not intended to limit the scope of the disclosure to such initial steps. Rather, it should be understood that additional steps may be performed, certain steps may be omitted, referenced steps may be performed in an alternative order or in parallel where appropriate, and so forth. However, disclosed orders of operation may be limiting when indicated as such.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A system, comprising:
a dynamic molding bed assembly wherein the dynamic molding bed assembly comprises:
a table frame;
a passive rod assembly comprising a plurality of rods, wherein each individual rod of the plurality of rods is configured to be independently adjusted to change a stroke length position relative to the table frame;
an actuator configured to couple to at least one individual rod of the plurality of rods to adjust the stroke length position of the at least one individual rod of the plurality of rods based on control instructions; and
a controller configured to:
generate instructions to adjust the stroke length position; and
activate the passive rod assembly to secure the at least one individual rod of the plurality of rods at the stroke length position.

2. The system of claim 1, wherein the passive rod assembly comprises:
a rod end effector disposed at a first end of the at least one individual rod and wherein the rod end effector is configured to be actuated by the actuator, wherein the actuator is a robotic device.

3. The system of claim 2, wherein the passive rod assembly comprises:
a mount;
a housing, wherein the housing is positioned at or near a second end of the at least one individual rod and wherein the housing is configured to receive at least a portion of the at least one individual rod of the plurality of rods; and
a spring, wherein the spring is configured to compress based on the stroke length position of the at least one individual rod of the plurality of rods during actuation by the robotic device.

4. The system of claim 2, wherein the passive rod assembly comprises:
a solenoid valve, wherein the solenoid valve is controlled by the controller, and wherein the solenoid valve is activated via the controller;
a rod lock, wherein the rod lock is configured to transition between a locked state and an unlocked state, and wherein the robotic device is configured to adjust the at least one individual rod of the plurality of rods to the stroke length position in the unlocked state;
a piston, wherein the piston is coupled to the at least one individual rod of the plurality of rods and wherein the piston extends through a housing based on the stroke length position; and
a rod gland, wherein the rod gland is configured to provide lateral support to the at least one individual rod of the plurality of rods from the housing.

5. The system of claim 4, wherein the controller is configured to monitor stroke length positions of the plurality of rods based on sensor data from a sensor.

6. The system of claim 5, wherein the controller is configured to:
determine stroke length positions of the plurality of rods based on sensor data;
control the actuator to actuate the individual rod of the plurality of rods to the stroke length position, wherein a spring is coupled to the piston extending from the individual rod of the plurality of rods;
activate the solenoid valve configured to control the rod lock; and
instruct the rod lock to secure the stroke length position of the individual rod of the plurality of rods.

7. The system of claim 1, wherein the actuator adjusts the stroke length position of the plurality of rods using a positive form or mold.

8. The system of claim 7, wherein each individual rod of the plurality of rods comprises a linear displacement sensor configured to send a signal to the controller indicative of the stroke length position of the individual rod.

9. The system of claim 1, wherein the actuator transitions from a default uncoupled state not in contact with the at least one rod of the plurality of rods to couple to the at least one rod of the plurality of rods.

10. A system, comprising:
a dynamic molding bed assembly wherein the dynamic molding bed assembly comprises:
a table frame;
a passive rod assembly comprising a plurality of rods, wherein at least one each individual rod of the plurality of rods is coupled to:
a rod end effector;
a mount;
a cylinder housing; and
a spring, wherein the spring is configured to compress based on a stroke length position of the at least one individual rod of the plurality of rods; and
a rod lock, wherein the rod lock is configured to transition from a locked state to an unlocked state, wherein the rod lock in the unlocked state is configured to allow adjustment of the stroke length position of the at least one individual rod of the plurality of rods; and
a controller configured to:
generate instructions to adjust the stroke length position of the at least one individual rod of the plurality of rods; and
activate the passive rod assembly to adjust the at least one individual rod of the plurality of rods to the stroke length position.

11. The system of claim 10, wherein the passive rod assembly comprises:
a solenoid valve, wherein the solenoid valve is controlled by the controller;
a piston, wherein the piston is coupled to the at least one individual rod of the plurality of rods and wherein the piston extends through the cylinder housing based on the stroke length position; and
a rod gland, wherein the rod gland is configured to provide lateral support to the at least one individual rod of the plurality of rods from the cylinder housing.

12. The system of claim 10, wherein the dynamic molding bed assembly includes one or more table frames, wherein the one or more table frames is configured to be modular, and wherein the one or more table frames is configured to be position on a single plane, one or more additional planes, or a combination thereof.

13. The system of claim 12, comprising a track, wherein a robotic device is configured to access the one or more table frames, via the track, and wherein the robotic device is coupled to the track by a track coupling disposed on a mount of the robotic device, and wherein the robotic device is configured to actuate the passive rod assembly.

14. The system of claim 1, wherein the actuator includes an actuation tool configured to adjust a rod end effector of the passive rod assembly.

15. The system of claim 10, wherein the dynamic molding bed assembly comprises a mold dam, wherein the mold dam is configured to provide boundaries during a printing process.

16. The system of claim 10, wherein a form is used to simultaneously adjust one or more rods of the plurality of rods to various stroke length positions.

17. A method of operating a dynamic molding bed assembly system, the method comprising:
receiving, via a controller, instructions indicative of a stroke length position corresponding to a first rod of a plurality of rods;
actuating, via an actuator, the first rod of the plurality of rods to the stroke length position; and
securing, via a rod lock, the stroke length position of the first rod of the plurality of rods.

18. The method of claim 17, comprising:
receiving, via the controller, instructions to move the actuator along a track, wherein the actuator is a robotic device, and wherein the robotic device is coupled to the track via a track coupling.

19. The method of claim 17, comprising:
actuating, via an actuation tool of the actuator, the first rod of the plurality of rods, wherein a piston extends from the first rod of the plurality of rods to a spring disposed with a cylinder housing on a second end of a passive rod assembly; and
actuating, via the piston, the spring along a spring path.

20. The method of claim 17, comprising:
receiving, via the controller, instructions, wherein the instructions comprise a topographical map based on a desired surface of an artificial rockwork panel;
adjusting, via the actuator, the stroke length position of each individual rod of the plurality of rods; and
initiating, via the controller, a printing process on a molding surface of the dynamic molding bed assembly system.
